(19) United States
(12) Patent Application Publication
(10) Pub. No.: US 2006/0248592 A1
(43) Pub. Date: Nov. 2, 2006

(54) SYSTEM AND METHOD FOR LIMITING DISCLOSURE IN HIPPOCRATIC DATABASES

(75) Inventors: RAKESH AGRAWAL, SAN JOSE, CA (US); GERALD GEORGE KIERNAN, SAN JOSE, CA (US); KRISTEN RIEDT LEFEVRE, MADISON, WI (US); RAMAKRISHNAN SRIKANT, SAN JOSE, CA (US); YI RONG XU, BEIJING 102208 (CN)

Correspondence Address: INTERNATIONAL BUSINESS MACHINES CORPORATION;INTELLECTUAL PROPERTY LAW, 650 HARRY ROAD, SAN JOSE, CA, 95120, US

(73) Assignee: INTERNATIONAL BUSINESS MACHINES CORPORATION, ARMONK, NY (US)

(21) Appl. No.: 10/908,145

(22) Filed: Apr. 28, 2005

(51) Int. Cl. G06F 17/30; H04N 7/16; G06F 12/14; G06F 7/00; H04L 9/32; G06F 11/30; G06F 7/04; G06K 9/00; H03M 1/68; H04K 1/00; H04L 9/00

(52) U.S. Cl. 726/26; 713/193; 707/9

(57) ABSTRACT

A tool for enforcing limited disclosure rules in a software application, typically an unmodified database. The invention enables individual queries to respect data subjects' preferences and choices by storing privacy semantics, classifying data items into categories, rewriting incoming queries to reflect stored privacy semantics, and masking prohibited values. Privacy semantics include individual data subject choices and privacy policies comprise rules describing authorized data recipients and authorized data access purposes. Privacy policies may require specific consent from data subjects. The invention assigns each (purpose, recipient) pair a view over each database table, so entire tuples and individual cells can have particular privacy semantics. Purposes and recipients are inferred based on the application issuing the query. Masking is performed at the individual cell level, and may employ NULL or other predetermined indicia for prohibited values. The invention is cost-efficient and scalable to large databases.

This invention generally relates to databases that prohibit outflow of data except when a privacy policy includes a rule permitting disclosure of the data to the appropriate recipient for the appropriate purpose. Specifically, the invention preserves privacy by enforcing limited disclosure rules in an unmodified database at cell-level granularity.

### BACKGROUND OF THE INVENTION

Preserving data privacy is of utmost concern in many business sectors, including e-commerce, healthcare, government, and retail, where individuals entrust others with their personal information every day. Often, the organizations collecting the data will specify how the data is to be used in a privacy policy, which can be expressed either electronically or in natural language.

The authors of [5] proposed the vision of a “Hippocratic” database that is responsible for maintaining the privacy of the personal information it manages. The authors proposed a framework for managing privacy sensitive information distilled down from the private data handling practices that are being demanded internationally, and mandated through legislation such as the United States Privacy Act of 1974 (Fair Information Practices), the EU Privacy Directive which took effect in 1998, the Canadian Standard Association's Model Code for the protection of Personal Information, the Australian Privacy Amendment Act of 2000, the Japanese Personal Information Protection Laws of 2003, and others. The framework is based on ten principles central to managing private data responsibly.

A vital principle among these is “limited disclosure,” which is defined to mean that the database should not communicate private information outside the database for reasons other than those for which there is consent from the data subject. (The term “data subject” means the individual whose private information is stored and managed by the database system.) A straightforward solution would be to implement this enforcement at the application, middleware, or mediator level, as is done in Tivoli Privacy Manager[6] and the TIHI security mediator[20]. However, this approach leads to privacy leaks when applied to cell-level privacy enforcement, as discussed below.

There has been extensive research in the area of statistical databases motivated by the desire to provide statistical information (sum, count, etc.) without compromising individual information (see survey in [4]). It was also shown that one cannot provide high quality statistics and at the same time prevent partial disclosure of individual data. (It is assumed that additional mechanisms such as query admission control and audit trails [4] are in place to guard against the inference problem.)

Prior work in the area of data security can largely be grouped into the areas of discretionary access control, role-based access control, and mandatory access control [18]. Discretionary access control allows a database to grant and revoke access privileges to individual database users. In this case, the access control privileges typically refer to entire tables or views. Role-based access control allows a database to grant this type of privilege not to an individual user, but the user's group, or role [19]. In the mandatory access control model, there is a single set of rules governing access to the entire system, and individual users are not allowed to grant or revoke access privileges.

A well-known model of mandatory access control, the Bell-LaPadula model of multilevel secure databases, defines permissions in terms of objects, subjects, and classes [8]. Each object is a member of some class, for example “Top Secret,” “Secret”, and “Unclassified,” and in this model, the classes typically form a hierarchy. Multi-level databases also allow for the possibility of polyinstantiation, where there exist data objects that appear to have different values to users with different classifications [11]. These formalizations have been further refined by [14] and [15], and a schema decomposition allowing element-level classification to be expressed as tuple-level classification is described in [17].

Multi-level security has been implemented at the row level in several products, including Oracle 8i's “Row Level Security” (also known as “Virtual Private Database”) feature, which allows specification of security policies at the row level, and augments incoming queries with additional predicates to respect the security policy[1]. Work was done to benchmark row-level classification in multi-level secure database systems[13]. The notion of “reformulating” queries for security was also alluded to by[20], and [3] uses a query rewrite mechanism to control access to federated XML user-profile data.

In some ways, the limited disclosure problem can be viewed as an adaptation of the problems arising from multi-level and role-based access control. The problem considers the task of assigning (purpose, recipient) pairs (the subjects) access to data cells (objects), which are grouped into data categories (classes). The privacy problem requires an additional degree of flexibility, however, as data assigned to a particular category does not necessarily all have the same access semantics because of conditional rules, like opt-in and opt-out choices. This leads to more complex permissions management. However, the privacy problem also allows for an important key simplification—polyinstantiation of data need not be allowed.

The only known implementation of a DBMS with cell-level access control was done by SRI in the SeaView system [11], but a performance evaluation was never published. Several content-management applications have enforced fine-grained security by introducing an application layer that modifies queries with conditions that enforce access control policies, for example [16], but they are application-specific in their design and do not extend a DBMS for general use. The wide use of ine-grained security by applications offers additional evidence that extending a DBMS with this capability is overdue.

An ideal solution to the limited disclosure problem would flexibly protect data subject information without leaks, and would incur minimal privacy “checking” overhead when processing queries. Because of the time and expense required to modify existing application code, an ideal solution would require minimal change to existing applications.

### SUMMARY OF THE INVENTION

It is accordingly an object of this invention to limit data disclosure in a software application, by enabling individual queries to respect data subjects' preferences and choices. The invention achieves this object by storing privacy semantics, classifying data items into categories, rewriting incoming queries to reflect stored privacy semantics, and masking prohibited values. In an exemplary embodiment, the software application is an unmodified database. The privacy semantics include individual data subject choices and privacy policies comprising rules describing authorized data recipients and authorized data access purposes. The privacy policies may require opt-in consent from data subjects for authorized data access, or may require opt-out consent from data subjects for data access to be denied. The masking is preferably performed at the individual cell level, and may employ a NULL value or another predetermined indicator value to denote a prohibited value.

The invention comprises a system, method, and computer program product that provides a high-performance cell-level solution to the limited disclosure problem by extending an application to support limited disclosure. Thus, the invention can be deployed to an existing environment without modification of existing applications.

The invention assigns each (purpose, recipient) pair a view over each database table, so that entire tuples and individual cells can have their own privacy semantics. In this embodiment, the purpose and recipient are inferred based on the application issuing the query. However, there are a multitude of alternative ways of defining and obtaining this information.

### BRIEF DESCRIPTION OF THE DRAWINGS

FIG. 1 is a table of patient information according to an embodiment of the invention.

FIG. 2 is a table of patient choices for disclosure of information to charities for solicitation according to an embodiment of the invention.

FIG. 3 is a table of privacy-enforced patient information using strict cell-level enforcement according to an embodiment of the invention.

FIG. 4 is a table of privacy-enforced patient information using table semantics according to an embodiment of the invention.

FIG. 5 is a comparison of table semantics and quern semantics for a simple projection according to an embodiment of the invention.

FIG. 6 is a diagram of the overall implementation architecture according to an embodiment of the invention.

FIG. 7 is a sample policy table from the privacy meta-data showing two sample rules according to an embodiment of the invention.

FIG. 8 is a sample data categories table from the privacy meta-data showing the mappings of data columns to the data categories used by the policies according to an embodiment of the invention.

FIG. 9 is a listing of a basic algorithm for rewriting queries for privacy enforcement according to an embodiment of the invention.

FIG. 10 is a listing of case statements for resolving privacy semantics of data attributes including choices stored as columns within the data table according to an embodiment of the invention.

FIG. 11 is a listing of an algorithm for filtering prohibited records using the table semantics model of enforcement according to an embodiment of the invention.

FIG. 12 is a listing of an algorithm for filtering prohibited records using the query semantics model of enforcement according to an embodiment of the invention.

FIG. 13 is a diagram of an alternative architecture that maps (purpose, recipient) pairs to views of each table according to an embodiment of the invention.

FIG. 14 is a graphical depiction of benchmark dataset and choice values being stored in the same table according to an embodiment of the invention.

FIG. 15 is a graphical depiction of total performance overhead of table semantics enforcement using case-statement rewrite with choice selectivity at 100% according to an embodiment of the invention.

FIG. 16 is a graphical depiction of CPU overhead of table semantics enforcement using case-statement rewrite with choice selectivity at 100% according to an embodiment of the invention.

FIG. 17 is a graphical depiction comparing the cost of executing rewritten and original queries for varying choice selectivity with application selectivity at 100% according to an embodiment of the invention.

FIG. 18 is a graphical depiction comparing case statement executed as a sequential scan and our join rewrite algorithms for indexed choice values according to an embodiment of the invention.

FIG. 19 is a graphical depiction of performance of queries executed over a privacy-preserving materialized view according to an embodiment of the invention.

### DETAILED DESCRIPTION OF THE INVENTION

First, the limited disclosure problem is described as it relates to a relational database. Next, several limited disclosure models for relational data and their semantics are described. A basic implementation architecture for limited disclosure and some optimizations to this architecture are provided. Finally, the performance of the implementation is evaluated.

Limited Data Disclosure

One of the defining principles of data privacy, limited data disclosure, is based on the premise that data subjects should be given control over who is allowed to see their personal information, and under what circumstances. For example, patients entering a hospital must provide some information at the time of admission. The patient understands that this information may only be used under certain circumstances. The doctors may use the patient's medical history for treatment, and the billing office may use the patient's address information to process insurance claims. However, the hospital may not give patient address information to charities for the purpose of solicitation without consent.

Frequently, an organization will define a privacy policy describing such an agreement. Comprised of a set of rules, the privacy policy is a contract between the individual providing the information and the organization collecting the information. Data items are classified into categories. For simplicity these categories are assumed to be mutually exclusive. For each category of data, the rules in the privacy policy describe the class of individuals who may access the information (the recipients), and how the data may be used (the purposes). The policy may specify that the data items belonging to a category may be disclosed, but only with “opt-in” consent from the subject. The policy may also specify that data items belonging to a category will be disclosed unless the subject has specifically “opted-out” of this default. There is much existing work regarding electronic privacy policy definition[2][7][10].

A solution to the problem of limited disclosure would ensure that the rules contracted in these privacy policies are enforced. More specifically, each query issued to the database would be issued in conjunction with a particular purpose and recipient. The database would prohibit the outflow of data, except when the privacy policy includes a rule permitting disclosure of the data to the appropriate purpose and recipient. Similarly, the database should restrict modification of data according to privacy policies. In the hospital example, a query issued for the purpose of “solicitation” and recipient “external charity” would only reveal the personal information of those patients who provided consent.

Limitations of Tuple Level Enforcement

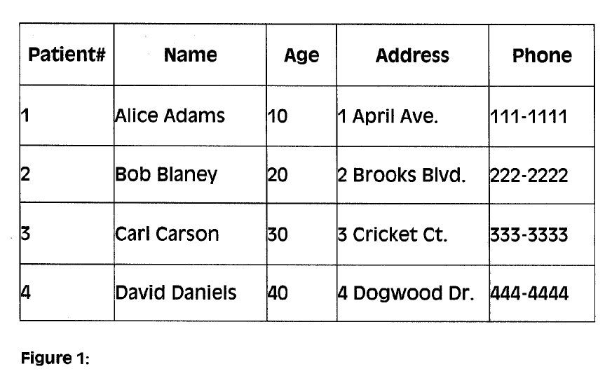

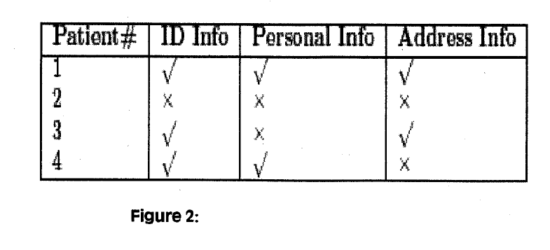

Consider a table containing patient information, as shown in FIG. 1. The data items “Name” and “Age” have been grouped into the data category “Personal Information.” Similarly, “Address” and “Phone” have been included in the “Address Information” category. The hospital allows patients to choose on an opt-in basis if they want these categories of information to be released to charities(recipient) for solicitation(purpose). FIG. 2 shows the choices made by the patients.

With row-level enforcement, clearly Alice's record should be visible to charities for solicitation, and Bob's record should be invisible. However, there is a problem with the records of Carl and David. In this case, one must either filter information that is actually permitted, or one must disclose information that is prohibited. In the following sections, three models of cell-level enforcement are described and then formally defined.

Strict Cell Level Enforcement

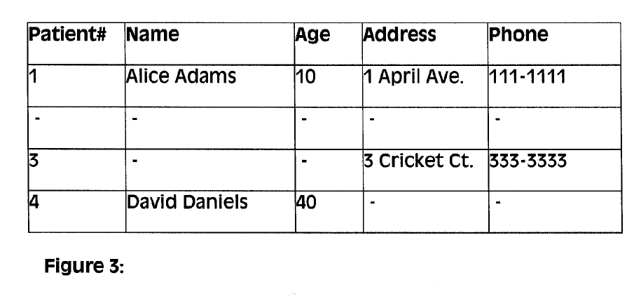

The above problem can be solved by defining a model of cell-level enforcement. One way of defining such a model would be to “mask” prohibited values using the NULL value. Each (purpose, recipient) is assigned a view of each table, T, in the database. Each view contains precisely the same number of tuples as the underlying table, but prohibited data elements are replaced with null. The view corresponding to the hospital example is given in FIG. 3. This model is termed Strict Cell-level enforcement.

Table Semantics Limited Disclosure Model

The strict cell-level model is attractive because of its simplicity. However, if one wants the privacy enforced data tables to be consistent with the relational data model, one must also ensure that the primary key is never null.

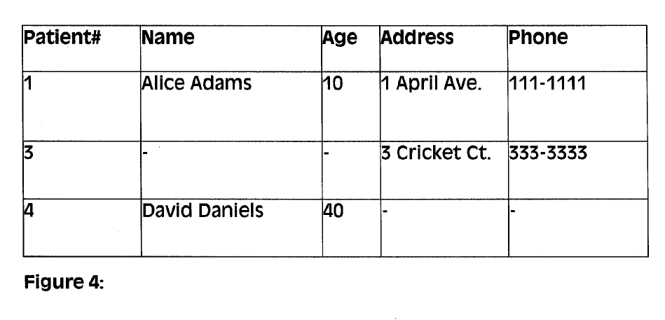

For this reason, another cell-level model is defined, which is termed Table Semantics enforcement. Here, one assigns each (purpose, recipient) pair a view over each table in the database, and as before, prohibited cells are replaced with null values. However, in this case one allows both entire tuples and individual cells to have privacy semantics. The privacy semantics of the primary key are used to indicate the privacy semantics of the entire tuple. If the primary key is prohibited, then the entire tuple is prohibited. When this model is applied to a table, the result is that prohibited tuples are filtered from the result set, and then any remaining prohibited cells are replaced with the null value, as is done in[11]. The resulting table of patients from the hospital example is shown in FIG. 4, assuming that Patient# is the primary key.

In SQL, NULL is a special value meant to denote “no value”[9]. Intuitively, it makes sense in the current problem to use null as a placeholder when a value is not available to a particular purpose and recipient. Adopting the semantics of SQL queries run against null values is desirable for several reasons:

Predicates applied to null values, such as X>null, will not evaluate to true. Because null values are defined this way, predicates applied to privacy enforced tables will behave as though the prohibited cells were not present.

Similarly, null values do not join with other values. Thus the results of a join query issued to one of the privacy enforced tables will produce results as if the null cells were not present. -Null values do not affect computation of aggregates, so an aggregate computed over a privacy enforced table is actually computed based only on the values available to the purpose and recipient.

There are some well-documented semantic anomalies inherent in the use of null values [9]. For example, the SQL expression AVG(Age) is not necessarily equal to the expression SUM(Age)/COUNT(*). An expression such as SELECT*FROM Patients WHERE AGE>50 OR AGE <=50, which might be expected to return all tuples in Patients, may not do so in the presence of nulls.

Replacing prohibited values with nulls makes some assumptions about the practical meaning of the null value. While it is not its intended use, in practice null may carry implied semantic meaning. In the hospital example, a null value in the Phone column may indicate that a patient has no phone. To alleviate this problem, one might consider defining a new data value, prohibited, carrying special semantics with regard to SQL queries, to act as a placeholder.

Query Semantics Limited Disclosure Model

The table semantics model defines a view of each data table for each (purpose, recipient) pair, based on the associated privacy semantics. These views combine to produce a coherent relational data model for each (purpose, recipient) pair, and queries are executed against the appropriate database version.

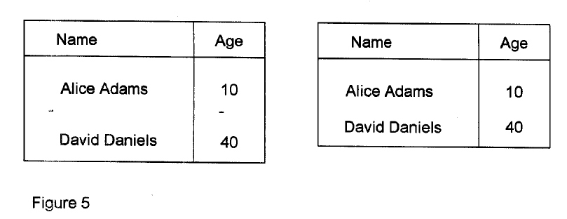

An alternative to this approach is to do enforcement based on the query itself. Unlike table semantics, here prohibited data is removed from a query's result set based on the purpose, recipient, and the query itself. This is termed the Query Semantics enforcement model. For example, using the hospital table, suppose one were to project the “Name” and “Age” columns from the Patients table. Using query semantics, the result of this query would be the table on the right of FIG. 5; using table semantics, one would obtain the table on the left. Because this model filters records in response to the issued query, and one does not aim to define a version of the underlying relation for each purpose and recipient, a tuple in the query result set may include a null value for an attribute that is part of the primary key in the underlying schema.

This model benefits from the same properties of null values discussed above. However, these semantics cause some anomalies in certain cases. Queries may observe different numbers of records depending on the column(s) projected. For example, if the Salary attribute is provided based on a condition, and the Name attribute is provided unconditionally, projecting the Name column will likely obtain more records than projecting the Salary column. In some cases these slight semantic departures buy substantial performance gains, as shown in the experimental results, but the semantic tradeoff should be carefully considered.

Application-Level Limited Disclosure

There are several possible approaches to implementing application-level privacy enforcement. One such approach is to first retrieve the requested data from the database, and then apply the appropriate enforcement before returning the data to the user. In a cell-level enforcement scheme, this approach leads to significant difficulties.

For example, consider a query involving a predicate over a privacy-sensitive field: SELECT*FROM PATIENTS WHERE DISEASE=Hepatitis, and a patient who chose to disclose his name, but not his disease history. An application-level enforcement scheme might do the following to execute this query: First, the application would issue the query to the database, and retrieve the result set. Then, the application would go through each of the resulting records, and based on the privacy semantics, replace prohibited cells with null. However, this approach is flawed. In the previous example, the query results would contain the patient's records, with the Disease field blocked out. Unfortunately, this allows anyone to conclude from looking at the results that this patient has Hepatitis, even though he had chosen not to share this information. This type of leakage is not a problem in the table semantics or query semantics model because data values that are not visible to a particular purpose and recipient are removed prior to query execution.

An alternative approach might select all of the Patient data from the database (in this example, this would include all patient records, not just those with a particular disease), and apply the predicate in the application. However, this leads to significant performance problems as it must fetch data unnecessarily from the database. Query execution is more difficult yet when more complicated queries are considered, such as those involving aggregates or joins, because a significant amount of data must be extracted from the database, and then a large amount of the query processing must be performed at the application level.

Implementation Architecture

A database architecture for efficiently and flexibly enforcing limited disclosure rules is described below. The basic components of this architecture are the following:

Policy definition: Privacy policies must be expressed electronically, and stored in the database where they can be used to enforce limited disclosure.

Query modifier: SQL queries entering the database should be intercepted, and augmented to reflect the privacy semantics of the purpose and recipient issuing the query. The results of this new query will be returned to the issuer.

Privacy meta-data: This is where the additional information to determine the correct privacy semantics of an incoming query is stored.

Data and Choice Tables: The data is stored in relational tables in the database. User choices (opt-in and opt-out) must also be stored in the database.

In the prototype, privacy policies are defined using P3P [10], and the privacy meta-data is stored in the database as ordinary relational tables. The prototype enforcement module is implemented as an extension to the JDBC driver, where queries are intercepted and rewritten to reflect the privacy semantics stored in the privacy meta-data. In the implementation, queries are issued via an HTTP servlet, forcing the use of the secure driver.

There are two ways to determine the purpose and recipient associated with a query. The first possibility is to extend the syntax of an SQL query to include this information. For example, SELECT*FROM Patients FOR PURPOSE Solicitation RECIPIENT External_Charity. The second possibility is to infer this information based on the application context, similar to the approach implemented in [1]. Because the first method requires extensions to the query language and modification to existing applications, the second option is elected, though the rest of the implementation is compatible with either alternative. The query interceptor infers the purpose and recipient of the query based on the issuing application. The context of each application must be specified, and in the prototype, the context information is stored in an additional database table. This information is then used to tag incoming queries with the appropriate privacy semantics based on the issuing application.

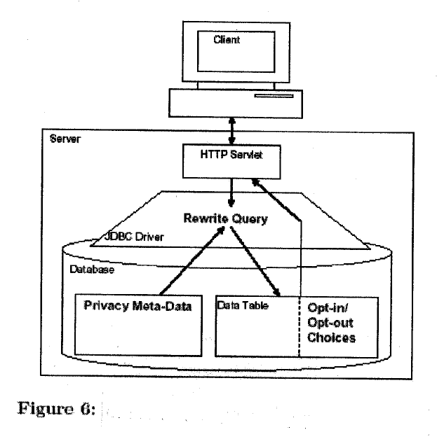

An overview of this architecture is given in FIG. 6. The query interception and modification component may be moved into the database's query processor without changing the general approach. Similarly, the privacy meta-data could be moved to an external mediator database, which would be responsible for intercepting and rewriting the query, as long as the user choices remain in the same database as the subject data. A description of the basic implementation is provided below, showing that it can be applied to any of the limited disclosure models described. Model-specific adjustments and optimizations are then described.

Architecture Overview

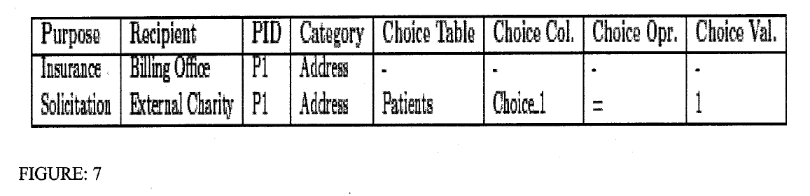

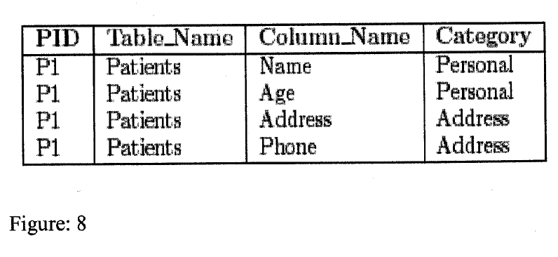

The disclosure rules from a specified privacy policy are stored inside the database, as the Privacy Meta-data. These tables capture the purpose and recipient information, as shown in FIG. 7, as well as conditions of the form attribute <opr> value, which are used to resolve conditional access, such as opt-in and opt-out choices. When a purpose P, recipient R, and data category D appear in a row of the policy table, this indicates that D is available to recipient R for purpose P. If this row contains condition values, it means that P and R may access D, but with restrictions as indicated by the condition. For example, the rules described in FIG. 7 indicate that address information is always provided to the billing office for the purpose of processing insurance claims, but address information is provided to external charities for solicitation only on an opt-in or opt-out basis. These tables also capture the identification of the privacy policy corresponding to each rule. Mappings of data columns to the broader categories used by privacy policies are also stored, as shown in FIG. 8.

In addition to storing the data disclosure rules, a mechanism for storing user choices must be provided. In the basic architecture, these values are stored in additional choice columns appended to the data tables themselves.

The basic enforcement mechanism intercepts and rewrites incoming queries to incorporate the privacy semantics stored in the privacy meta-data tables, as well as the user choices. The mechanism uses case-statements to resolve choices and conditions, and applies additional predicates to filter prohibited records from the result set. The query rewrite scheme is a straightforward SQL implementation of the enforcement definition.

Consider, for example, a data table Patients, containing an attribute Phone. Under the privacy policy that is in place, the Phone attribute is included in the Address category, which is made available to charities for the purpose of solicitation on an opt-in basis. The user choices for Address information are stored in column Choice_{—}1. The choices for the primary key of the patients table, ID, are stored in column Choice_{—}2. Suppose the following query is issued for this recipient and purpose:

SELECT Phone FROM Patients

This query can be rewritten to resolve this particular condition as follows, using the table semantics model:

SELECT

CASE WHEN Choice_{—}1=1 THEN Phone ELSE null END

FROM Patients AS q1(Phone)

WHERE Choice_{—}2=1

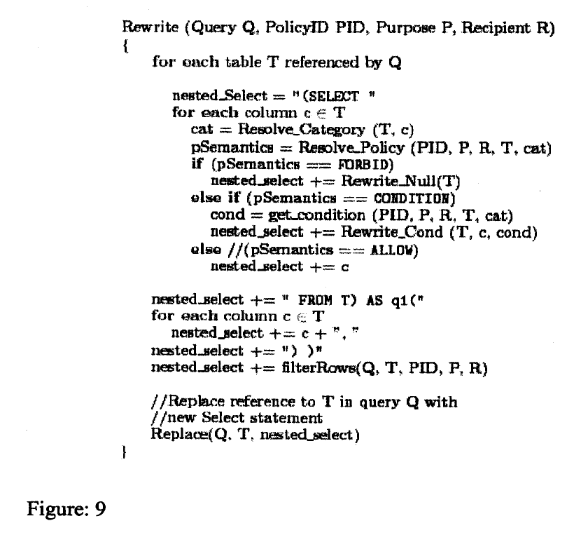

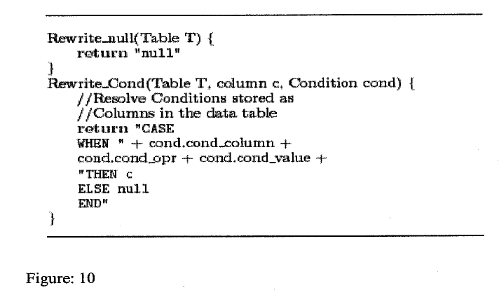

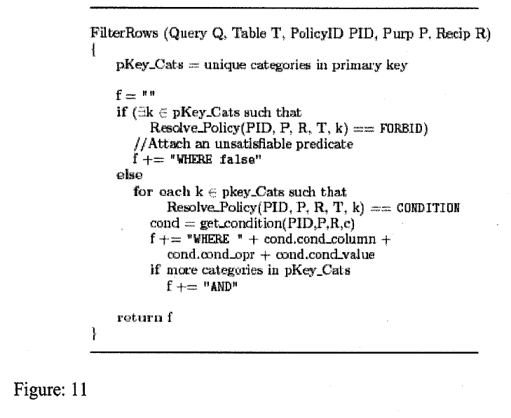

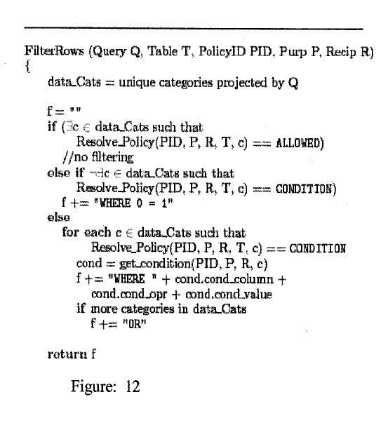

Similar rewriting techniques resolve the privacy semantics of both allowed and prohibited categories. The rewriting algorithm is given in FIG. 9, and the algorithm for resolving conditions is given in FIG. 10. The Resolve_Category( ), Resolve_Policy( ), and get_Condition( ) functions mentioned in the algorithms are implemented as simple queries to the privacy meta-data tables. When the policy store table contains no rule corresponding to a particular purpose and recipient, the Resolve_Policy( ) function evaluates to FORBID. If the policy table contains an appropriate rule, but the values of the condition columns are null, then Resolve_Policy( ) evaluates to ALLOW. Otherwise, it evaluates to CONDITION. The FilterRows( ) function removes prohibited rows from the result set, as indicated by either the table semantics (FIG. 11) or query semantics (FIG. 12) model.

Implementing Enforcement Using Views

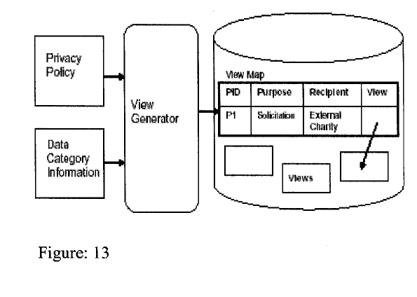

An alternative architecture becomes apparent in the case of table-semantics enforcement. In this case, it is possible to achieve the same enforcement using views, while circumventing the overhead of rewriting incoming queries. This simplifies the architecture greatly by capturing all of the information from the meta-data tables described in the previous architecture in a single table mapping (purpose, recipient) pairs to privacy views of each table, as shown in FIG. 13. These views can be defined using the same case-statement mechanism described above, and at most one view for each (purpose, recipient, policy) combination needs to be defined.

These views may be constructed once at policy installation time, in which case there is no longer any need to store the privacy policy table or the category table. Alternatively, the invention may continue to store this information and lazily construct and cache these views as each is requested. In either case, the invention intercepts incoming queries, and based on the purpose and recipient information, redirects them to the appropriate view.

There is a complication to this approach when application queries with predicates over indexed data columns are considered. Consider for example the following query over a data table in which SSN is an indexed data value, and the disclosure of SSN is governed by some choice stored in Choice_{—}2. Name is a non-indexed data value, and disclosure of Name is governed by Choice_{—}1. For simplicity, primary-key based filtering is ignored in this example:

SELECT SSN, Name

FROM Participants

WHERE SSN=222-22-2222

In this case, the query is translated to:

SELECT SSN, Name

FROM (SELECT CASE WHEN CHOICE_{—}2=1 THEN SSN ELSE null END,

CASE WHEN CHOICE_{—}1=1 THEN Name ELSE null END

FROM Participants) AS q1(SSN, Name)

WHERE q1.SSN=222-22-2222

Unfortunately, executing this query in DB2 causes the index on SSN to be discarded because the reference to SSN is buried inside a case-statement. To fix this problem, the indexed data attribute and the corresponding choice can be pulled out to the predicate, where the index can more easily be applied:

SELECT SSN, Name

FROM (SELECT SSN,

CASE WHEN CHOICE_{—}1=1 THEN Name ELSE null END,

Choice_{—}2

FROM Participants) AS q1(SSN, Name, Choice_{—}2)

WHERE q1.SSN=222-22-2222 AND q1.Choice_{—}2=1

As this optimization is based on the query itself, it cannot be incorporated into the view definition without substantial additions to the database engine. The choice may only be pulled out to the predicate when the query includes a predicate on the particular attribute.

Alternative Rewrite Algorithm

An alternative to the case-statement rewrite mechanism implements the Table Semantics and Query Semantics enforcement models using the left outer join and full outer join operators respectively.

Consider the same query translated using the case-statement algorithm, with privacy semantics as described previously:

SELECT Phone FROM Patients

This query can be rewritten as follows to reflect the table semantics enforcement model:

(SELECT ID WHERE Choice_{—}2=1) AS t1 (ID)

LEFT OUTER JOIN

(SELECT

ID, Phone WHERE Choice_{—}1=1

FROM Patients AS q1 (Phone)

WHERE Choice_{—}2=1) AS t2(ID, Phone)

ON t1.ID=t2.ID

The translation scheme for table semantics is an SQL implementation of the following relational algebra expression; the full SQL algorithm is omitted for brevity. Consider some query Q; each table T referenced by Q contains some attributes, a1 . . . an. For simplicity, assume these attributes belong to separate categories. Let k represent the primary key of T, and for simplicity assume that the primary key is comprised of just one column. Replace Q's reference to T with the following, where “∝” denotes the left outer join operator:
[σₖ=“Allowed”(Πₖ(T))]∝_{$I=$1}[σₐ₁=“Allowed”(Π_{k,a1}(T))]∝_{$1=$1} . . . ∝_{$1=$1}[σₐₙ=“Allowed”(Π_{k,an}(T))]

A similar scheme is provided for query semantics. Consider a query Q which projects a set of columns from some set of tables. For each such table T, let p1 . . . pn denote the columns of T projected by Q, and let k be the primary key of T. Again, assume each category contains just one column, and the primary key contains just one column. The scheme replaces the reference to T by Q with the following, where “x” denotes the full outer join operator:
[σₚ₁=“Allowed”(Π_{k,p1}(T))]×_{$1=$1}[σₚ₂=“Allowed”(Π_{k,p2}(T))]×_{$1=$1v$3=$1} . . . ×_{$1=$1v$3=$1v} . . . [σₐₙ=“Allowed”(Π_{k,an}(T))]

It is worth noting that in DB2 the outer join rewrite algorithm cannot be applied to queries of the form “SELECT FOR UPDATE” because of the join operators involved. This is similar to the fact that, in general, views joining multiple tables are not updatable. However, in this case, there is a straightforward translation from the view update to a table update, so in the future the database system could be extended to handle this situation.

The SeaView system took a similar approach in constructing cell-level access control [11]. In the SeaView system, multilevel relations existed only at the logical level, as views of the data. They were actually decomposed into a collection of single-level tables, which were physically stored in the database. The multi-level relations were recovered from the underlying relations using the left outer join and union operators. However, there are important performance implications in choosing to use an outer join rewrite algorithm for limited disclosure, as discussed below.

PERFORMANCE EVALUATION: Extensive experiments were performed to study the performance of the invention and of query modification as methods of enforcing limited disclosure. The experiments are intended to address the following key questions:

Overhead of Privacy Enforcement: What is the overhead cost introduced by privacy checking? This question is addressed through an experiment that factors out the impact of choice selectivity. In the worst case, the cost of checking privacy semantics is incurred, but no performance gain by filtering prohibited tuples from the result set is seen.

Scalability: The scalability of the rewrite scheme is tested in terms of database size and application selectivity. Both the percentage of users who elect to share their data for a particular purpose and recipient (choice selectivity), and the percentage of the records selected by an issued query (application selectivity) are varied.

Except where otherwise noted, the experiments use cell-level enforcement, but make the simplifying assumption that access to all columns in the data table is based on a single opt-in/opt-out choice. This means that every record is either fully visible or fully invisible; however, for the case-statement rewrite mechanism cell-level enforcement is still performed by evaluating a case statement over each column. In the table semantics model, this assumption does not influence execution time. If the primary key is allowed, then the tests fetch the tuple and process a case statement for each cell. For the query semantics model, the number of independent “optable” columns only influences performance insofar as it influences the number of tuples retrieved, so it is possible to assess the performance of “multi-category” tables using a single category evaluation. The number of independent data categories in a table does influence the performance of the outer join algorithm, as it dictates the number of joins necessary.

Impact of Filtering: In both the table and query semantics models, there are cases where tuples are filtered entirely from the result set of a query. An experiment is performed to show the impact of this filtering.

Enforcement Model: The performance implications of choosing the Table Semantics or Query Semantics enforcement model are studied.

Rewrite Algorithms—Case vs. Outer Join: The performance of the case-statement and the outer join rewrite algorithms are briefly compared.

Views vs. Complete Query Rewrite: The tradeoff between defining and caching privacy views and performing complete query rewrite for table semantics enforcement are discussed. The cost of completely rewriting queries in a Java prototype implementation is measured. The implications of materializing the privacy-preserving view are also discussed.

Choice Storage: The implications of choosing among the various modes of choice storage are discussed.

There are several distinct sources of performance cost in the embodiment, which were isolated in the performance experiments.

Query Rewrite: The invention intercepts and rewrites queries. This component includes indexed lookup queries to the privacy meta-data. The cost of rewriting a query is constant in the number of columns and categories in the underlying table schema, and relatively small compared to the cost of executing the queries themselves.

Query Execution: The cost of executing the rewritten query includes some amount of I/O, CPU processing, and the cost of returning the resulting data to the application.

Experimental Setup

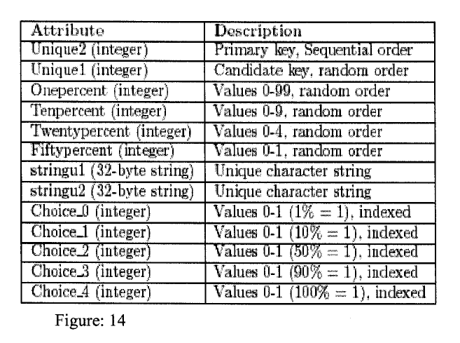

The performance of the invention was measured using a synthetically-generated dataset, based on the Wisconsin Benchmark[12]. The synthetic data schema is described in FIG. 14. All experiments were run on a single 750 MHz processor Intel Pentium machine with 1 GB of physical memory, using DB2 UDB 8.1 and Windows XP Professional 2002. The buffer pool size was set to 50 MB, and the pre-fetch size was set to 64 KB. All other DB2 default settings were used, and the query rewrite algorithms were implemented in Java. The system clock measured the cost of rewriting queries.

The DB2batch utility measured the cost of executing queries. Each query was run 6 times, flushing the buffer pool, query cache, and system memory between unique queries. The results given below represent the warm performance numbers, the average of the last 5 runs of each query. The size of the data table is 5 million records, except where otherwise noted.

Experimental Results and Analysis

Overhead and Scalability

The first set of experiments measures the overhead cost of performing privacy enforcement and the scalability of the invention to large databases. To measure this cost, simple selection queries are considered, with predicates applied to non-indexed data columns. Results are reported for the table semantics privacy enforcement model, but the trends are similar for query semantics. It is assumed, as described previously, that all columns in the table belong to a single data category, with a single choice value. To measure the overhead cost of enforcement, the worst case scenario is considered as described above, where the choice selectivity is 100%, so all the cost of privacy processing is incurred, but the performance gains of filtering are not seen.

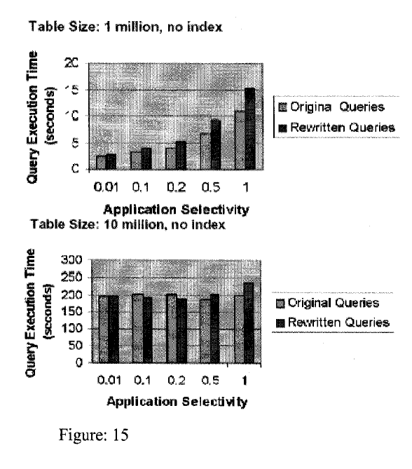

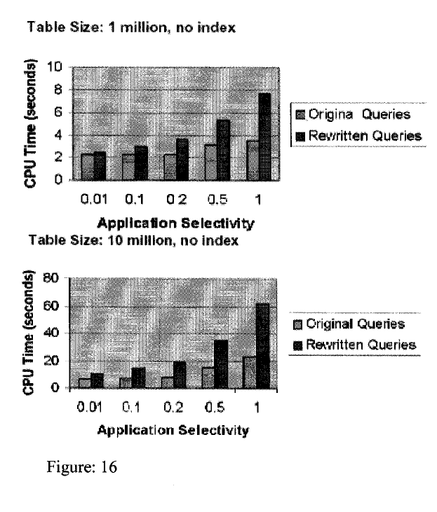

FIG. 15 shows the overhead cost of executing queries rewritten for privacy enforcement over tables containing 1 million and 10 million records. The graphs show the total execution time for queries with various application selectivity levels, and of the same queries rewritten using the case-statement rewrite algorithm. In all of these examples, the query plan is a sequential scan. The rewritten queries show the overhead of processing the additional case statement for each cell. FIG. 16 shows the CPU time used in executing these same queries, in particular the extra cost of processing the additional case statements.

Because the figures show the warm performance numbers, the results of queries over the 1 million-tuple table can largely be processed from the buffer pool. In the case of the 10 million-tuple table, however, the size of the table exceeds the size of the buffer pool and the query processing incurs disk I/O. Thus, in the case of the former, the cost is dominated by the CPU time spent processing the case statements, whereas in the latter, the cost is dominated by I/O. As the application filters fewer tuples, the CPU cost increases, but because the queries are executed as sequential scans, the I/O cost does not change, explaining FIGS. 15 and 16. The total cost increases when the table size is increased from 1 million to 10 million records, but this cost is dominated by the I/O.

Implications of Filtering due to Choice Selectivity

In cases with choice selectivity less than 100%, the rewritten queries perform significantly better because, through the use of a choice index, they need to read fewer tuples. In this experiment, the application query selects all 5 million records in the table. However, the rewritten queries vary the choice selectivity. Note that in this experiment, the queries with a choice selectivity of 0.01, 0.1, and 0.5 used the index on the choice column; the others did not.

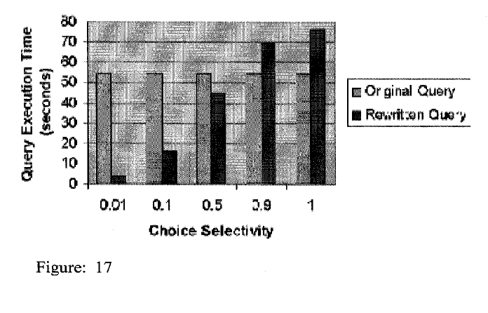

As can be seen from FIG. 17, the performance gain is considerable for low choice selectivity. When the choice selectivity is near 100%, the cost of privacy checking is incurred, but no benefit from choice selectivity is seen. Still, the cost of enforcement is quite low.

Performance Differences Among Enforcement Models

There is a clear performance distinction between the table semantics and the query semantics privacy models, which becomes clear when a table comprised of columns belonging to different data categories, with independent privacy rules, is considered.

In the table semantics model, a tuple is filtered from the result set if the primary key is forbidden. In this case, if the underlying table schema is defined as suggested above, and a record is made visible if any of its attributes are visible, then it is convenient to think of the independent choice selectivities for all of the projected columns combining to form the effective choice selectivity. When considering some table, T, containing x categories, such that the choice selectivities for the categories are independent of one another, the effective selectivity can be determined by
1−Πᵢ₌₁^{x}(1−sᵢ)
where sᵢ is the choice selectivity corresponding to category i. This is not the case when the query semantics model is considered. Here, the effective choice selectivity is not determined by the underlying table schema; instead it is determined by the selectivities of only those columns projected by the query. In many situations, this leads to substantial performance gain, as fewer tuples need to be read and returned.

However, in some situations, this performance gain may be offset because the query semantics rewrite algorithm yields a query that is less likely to use indices on the choice columns. For instance, if the query projects two columns belonging to two separate categories, in the query semantics model, the filtering predicate might include a disjunction of the form, WHERE Choice_{—}0=1 OR Choice_{—}1=1. It was observed that when executing the above predicate, the optimizer does not make use of the indices on either Choice_{—}0 or Choice_{—}1 even though the combined selectivity of the two choices is low. It is possible that the choice indexes were not incorporated in the query plan because of the disjunction in the predicate.

Comparing Rewrite Algorithms

In most situations, the case-statement rewrite algorithm substantially outperforms the outer-join rewrite algorithm, and for good reason. The outer join algorithm scales poorly because of the repeated and costly join operations involved. For large tables with high choice selectivity (many tuples selected), the performance was quite poor, so these results are omitted.

However, there are some specific situations where the outer join algorithm does perform better than using case-statements. For example, in the previous section it was observed that the DB2 optimizer did not use choice indexes for a query with a predicate including a disjunction of conditions. However, the outer join rewriting algorithm was more likely to be able to use such indexes.

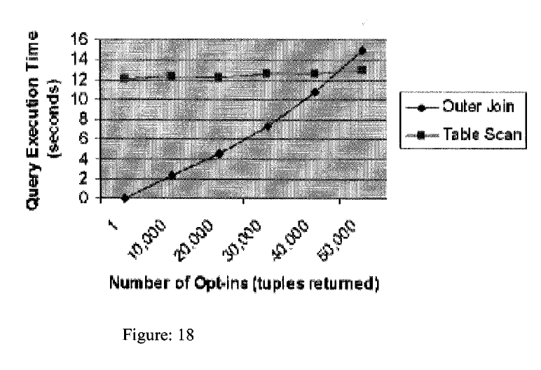

FIG. 18 compares the performance of the outer join rewritten query with a case-statement rewritten query performing a sequential scan. These are the results for a query consisting of two categories and performing query semantics enforcement, so the outer join query includes one join. A complete characterization of conditions under which the outer join rewrite algorithm should be selected over the case-statement algorithm is the subject of future work.

Query Rewriting vs. Views

As shown above, it is possible to implement a table semantics enforcement mechanism by redirecting incoming queries to predefined privacy views, rather than entirely rewriting the incoming queries. In practice, these two methods yield identical query execution performance, except when additional rewriting must be performed to avoid discarding a useful index, as explained above. In this case, the performance impacts of not using an index may be substantial.

The views implementation avoids much of the cost of rewriting queries to reflect the privacy semantics. However, this cost is constant in the number of columns, and for large tables and complex queries, small compared to the cost of executing the queries themselves. The cost of querying the privacy meta-data is negligible because these queries are implemented as simple indexed lookups. For eight columns, from distinct data categories, the average time to rewrite a query in the Java implementation averaged approximately 0.15 seconds when the privacy meta-data connections were pooled.

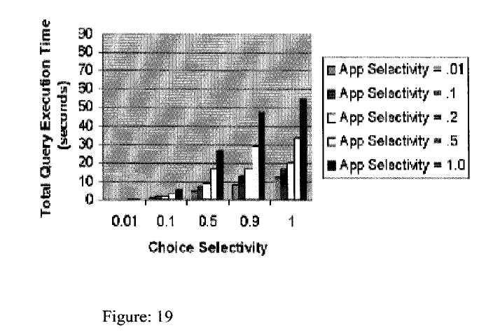

An alternative, feasible only as a method of optimizing performance for a few (purpose, recipient) pairs, is actually materializing the view. Querying the materialized view is very inexpensive, as shown in FIG. 19, though one must take into account the effort needed to maintain the view as the underlying data tables are updated. For each data table, this solution requires storing one table, which could be as large as the original data table, per (purpose, recipient) pair.

### CONCLUSION

Limited disclosure is a vital component of a data privacy management system. Several models for limited disclosure in a relational database are presented, along with a proposed scalable architecture for enforcing limited disclosure rules at the database level. Application-level solutions are inefficient and unable to process arbitrary SQL queries without leaking private information. By pushing the enforcement down to the database, improved performance and query power are gained without modification of existing application code.

The performance overhead of privacy enforcement is small and scalable, and often the overhead is more than offset by the performance gains obtained through tuple filtering. Queries run on tables that are sparse due to many values being masked to limit data disclosure may execute significantly faster than usual, so query optimization methods may be substantially more effective when they consider data that has been masked.

A general purpose computer is programmed according to the inventive steps herein. The invention can also be embodied as an article of manufacture—a machine component—that is used by a digital processing apparatus to execute the present logic. This invention is realized in a critical machine component that causes a digital processing apparatus to perform the inventive method steps herein. The invention may be embodied by a computer program that is executed by a processor within a computer as a series of computer-executable instructions. These instructions may reside, for example, in RAM of a computer or on a hard drive or optical drive of the computer, or the instructions may be stored on a DASD array, magnetic tape, electronic read-only memory, or other appropriate data storage device.

While the particular SYSTEM AND METHOD FOR LIMITING DISCLOSURE IN HIPPOCRATIC DATABASES as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for”.

### REFERENCES

[1] govt.oracle.com/tkyte/article2/index.html.
[2] extensible access control markup language (XACML) version 1.0 specification, February 2003. OASIS Standard.
[3] Privacy conscious user profile data management with GUPster. Tech. report, Bell Laboratories, Lucent Technologies, 2003.
[4] N. Adam and J. Wortman. Security-control methods for statistical databases. ACM Computing Surveys, 21(4):515-556, Dec. 1989.
[5] R. Agrawal, J. Kiernan, R. Srikant, and Y. Xu. Hippocratic databases. In Proc. of the 28th Int. Conf. on Very Large Data Bases, Hong Kong, China, August 2002.
[6] P. Ashley and D. Moore. Enforcing privacy within an enterprise using IBM Tivoli Privacy Manager for e-business, May 2003.
[7] R. Ashley, S. Hada, G. Karjoh, C. Powers, and M. Schunter. Enterprise privacy authorization language 1.1 (EPAL 1.1) specification. IBM Research Report, June 2003.
[8] D. Bell and L. LaPadula. Secure computer systems: Unified exposition and multics interpretation. Technical Report ESD-TR-75-306, MITRE Corp., Bedford, Mass., March 1976.
[9] D. Chamberlain. A Complete Guide to DB2 Universal Database. Morgan Kauffmann, San Francisco, Calif., USA, 1998. Chapter 1.3.3.
[10] L. Cranor, M. Langheinrich, M. Marchiori, M. Pressler-Marshall, and J. Reagle. The platform for privacy preferences 1.0 (P3P1.0) specification. W3C Recommendation, April 2002.
[11] D. Denning, T. Lunt, R. Schell, W. Shockley, and M. Heckman. The SeaView security model. IEEE Trans. on Software Eng., 16(6):593-607, June 1990.
[12] D. DeWitt. The Wisconsin benchmark: Past, present, and future. In J. Gray, editor, The Benchmark Handbook. Morgan Kaufmann, 1993.
[13] V. Doshi, W. Herndon, S. Jajodia, and C. McCollum. Benchmarking multilevel secure database systems using the MITRE benchmark. In 10th Annual Computer Security Applications Conf., December 1994.
[14] S. Jajodia and R. Sandhu. Polyinstatiation integrity in multilevel relations. In IEEE Computer Society Symp. on Research in Security and Privacy, May 1990.
[15] S. Jajodia and R. Sandhu. A novel decomposition of multilevel relations into single-level relations. In IEEE Symp. on Security and Privacy, Oakland, Calif., USA, May 1991.
[16] N. Kabra, R. Ramakrishan, and V. Ercegovac. The QUIQ Engine: A hybrid IR-DB system. In Proc. Int. Conf. on Data Engineering, Bangalore, India, March 2003.
[17] X. Qian and T. Lunt. Tuple-level vs. element-level classification. In Database Security, VI: Status and Prospects. Results of the IFIP WG 11.3 Workshop on Database Security, Vancouver, Canada, August 1992.
[18] R. Ramakrishnan and J. Gehrke. Database Management Systems. McGraw-Hill, 3rd edition, 2003. Chapter 21.
[19] R. Sandhu, E. Coyne, H. Feinstein, and C. Youman. Role-based access control models. IEEE Computer, 29(2):38-47, February 1996.

[20] G. Wiederhold, M. Bilello, V. Sarathy, and X. Qian. A Proceedings of the 1996 AMIA Conference, security mediator for healthcare information. In Washington, D.C., October 1996.

What is claimed is:

1. A computer-implemented method for limiting data disclosure in a software application, comprising:
storing privacy semantics;
classifying data items into categories;
rewriting incoming queries to reflect stored privacy semantics; and
masking prohibited values.

2. The method of claim 1 wherein the software application is an unmodified database.

3. The method of claim 1 wherein the privacy semantics include privacy policies and individual data subject choices.

4. The method of claim 3 wherein the privacy policies comprise rules describing authorized data recipients and authorized data access purposes.

5. The method of claim 4 wherein each (purpose, recipient) pair is assigned a view over each database table, so that entire tuples and individual cells can have particular privacy semantics.

6. The method of claim 4 wherein the privacy policies require at least one of: opt-in consent from data subjects for authorized data access and opt-out consent from data subjects for data access to be denied.

7. The method of claim 1 wherein the masking is performed at the individual cell level.

8. The method of claim 1 wherein the masking employs NULL to indicate a prohibited value.

9. The method of claim 1 wherein the masking employs a predefined non-NULL value to indicate a prohibited value.

10. A system for limiting data disclosure in a software application comprising:
means for storing privacy semantics;
means for classifying data items into categories;
means for rewriting incoming queries to reflect stored privacy semantics; and
means for masking prohibited values.

11. The system of claim 10 wherein the masking is performed at the individual cell level.

12. A computer program product comprising a computer useable medium including a computer readable program that causes a computer system to limit data disclosure in a software application by:
storing privacy semantics;
classifying data items into categories;
rewriting incoming queries to reflect stored privacy semantics; and
masking prohibited values.

13. The product of claim 12 wherein the software application is an unmodified database.

14. The product of claim 12 wherein the privacy semantics include privacy policies and individual data subject choices.

15. The product of claim 12 wherein the privacy policies comprise rules describing authorized data recipients and authorized data access purposes.

16. The product of claim 15 wherein each (purpose, recipient) pair is assigned a view over each database table, so that entire tuples and individual cells can have particular privacy semantics.

17. The product of claim 15 wherein the privacy policies require at least one of: opt-in consent from data subjects for authorized data access and opt-out consent from data subjects for data access to be denied.

18. The product of claim 12 wherein the masking is performed at the individual cell level.

19. The product of claim 12 wherein the masking employs NULL to indicate a prohibited value.

20. The product of claim 12 wherein the masking employs a predefined non-NULL value to indicate a prohibited value.
